(19) United States
(12) Patent Application Publication
(10) Pub. No.: US 2026/0298189 A1
(43) Pub. Date: Oct. 1, 2026

(54) Control Device Of Internal Combustion Engine For Portable Work Machine, And Portable Work Machine

(71) Applicant: YAMABIKO CORPORATION, Tokyo (JP)

(72) Inventors: Hisato ONODERA, Ohme-shi (JP); Yuya FUJII, Ohme-shi (JP); Takuma NAKA, Ohme-shi (JP)

(21) Appl. No.: 19/571,767

(22) Filed: Mar. 19, 2026

(30) Foreign Application Priority Data
Mar. 28, 2025 (JP) 2025-056511

(51) Int. Cl. F02P 5/15

(52) U.S. Cl. CPC F02P 5/15

(57) ABSTRACT

A control device of an internal combustion engine for a portable work machine is provided that can suppress overspeed of the engine. The control device of the internal combustion engine for the portable work machine performs control of the internal combustion engine of the portable work machine, the portable work machine including the internal combustion engine including a combustion chamber, an ignition plug that ignites an air-fuel mixture supplied to the combustion chamber, and a crankshaft as an output shaft. When the rotational speed of the crankshaft reaches the predetermined target rotational speed, the control device performs ATDC switching control in which an ignition timing of the ignition plug is switched from a timing before top dead center to a timing after the top dead center, and skip-fire control in which the number of ignitions of the ignition plug per rotation is reduced.

### CROSS-REFERENCE TO RELATED APPLICATIONS

This application claims the benefits of Japanese Patent Application No. 2025-56511 filed on Mar. 28, 2025 in the Japanese Patent Office, the disclosure of which is incorporated herein in its entirety by reference.

### FIELD OF THE INVENTION

The present invention relates to a control device of an internal combustion engine for a portable work machine, and to a portable work machine.

### BACKGROUND OF THE INVENTION

In recent years, there has been a trend of increase in the maximum rotational speed of engines for large-sized portable work machines (large-sized brush cutters or the like) due to the influence of demands for engine performance with higher output.

When the maximum rotational speed of an engine is increased far beyond a target rotational speed (overspeed occurred) or the maximum rotational speed during working varies widely, increased vibration can affect a user's feelings (the way the user feels vibration or perceives sound) or can increase concern about durability of the work machine.

Meanwhile, Japanese Laid-open patent publication NO. 2008-19863 discloses that, in a high-speed range (high-speed rotation range) of an internal combustion engine, the rotational speed is reduced by shifting the ignition timing of an ignition plug toward a top dead center or by reducing the number of ignitions as compared with the rotational speed.

However, from studies by the inventors of the present application, there is still room for improvement in the technique of Japanese Laid-open patent publication NO. 2008-19863 in terms of suitably suppressing overspeed in the high-speed range and rotational speed fluctuation near the maximum rotational speed.

The present invention has been made in view of the above-described problems and provides a control device of an internal combustion engine for a portable work machine that is capable of suppressing overspeed of the internal combustion engine of the portable work machine more suitably, and also provides a portable work machine.

### SUMMARY

According to the present invention, there is provided a control device of an internal combustion engine for a portable work machine, the control device being configured to perform control of the internal combustion engine of the portable work machine, the portable work machine including the internal combustion engine including a combustion chamber, an ignition plug that ignites an air-fuel mixture supplied to the combustion chamber, and a crankshaft as an output shaft,
wherein, when the rotational speed of the crankshaft reaches a predetermined target rotational speed, the control device performs ATDC switching control in which an ignition timing of the ignition plug is switched from a timing before a top dead center to a timing after the top dead center, and skip-fire control in which the number of ignitions of the ignition plug per rotation is reduced.

In addition, according to the present invention, there is provided a portable work machine including an internal combustion engine including: a combustion chamber; an ignition plug that ignites an air-fuel mixture supplied to the combustion chamber; a crankshaft as an output shaft; and a control unit,
wherein the control unit is configured to perform ATDC switching control in which an ignition timing of the ignition plug is switched from a timing before top dead center to a timing after the top dead center, and skip-fire control in which the number of ignitions of the ignition plug per rotation is reduced, when the rotational speed of the crankshaft reaches the predetermined target rotational speed.

### Advantageous Effect of Invention

According to the present invention, overspeed of the internal combustion engine of the portable work machine can be suppressed more suitably.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a perspective view of a brush cutter according to an embodiment;

FIG. 2 is a cross sectional view of an apparatus main body of the brush cutter according to an embodiment;

FIG. 3 is a diagram illustrating a configuration of main blocks of the brush cutter according to an embodiment;

FIG. 4 is a graph illustrating control by control devices of brush cutters according to an embodiment and a comparative example, in which the axis of abscissas represents the rotational speed and the axis of ordinates represents ignition timing (crank angle) relative to a top dead center;

FIG. 5 is a chart illustrating operations when the control device of the brush cutter according to an embodiment is normally driven;

FIG. 6 is a chart illustrating operations when the control device of the brush cutter according to an embodiment performs ATDC switching control and skip-fire control;

FIG. 7 is a graph showing the relationship between fuel flow rate and the rotational speed of the brush cutter according to an embodiment and the brush cutter according to a comparative example;

FIG. 8 is a graph showing the relationship between the rotational speed and vibrations of the brush cutter according to an embodiment;

FIG. 9 is a graph showing the relationship between the rotational speed and the vibrations of the brush cutter according to a comparative example;

FIG. 10 is a graph showing the relationship between the rotational speed and the vibrations of the brush cutter according to an embodiment and the brush cutter according to a comparative example; and

FIG. 11 is a chart illustrating operations when a control device of a brush cutter according to a modification example performs ATDC switching control and skip-fire control.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Hereinafter, an embodiment of the present invention will be described with reference to the drawings. Note that in all of the drawings, similar constituent elements will be given the same reference signs, and the description may be omitted as appropriate.

### Embodiment

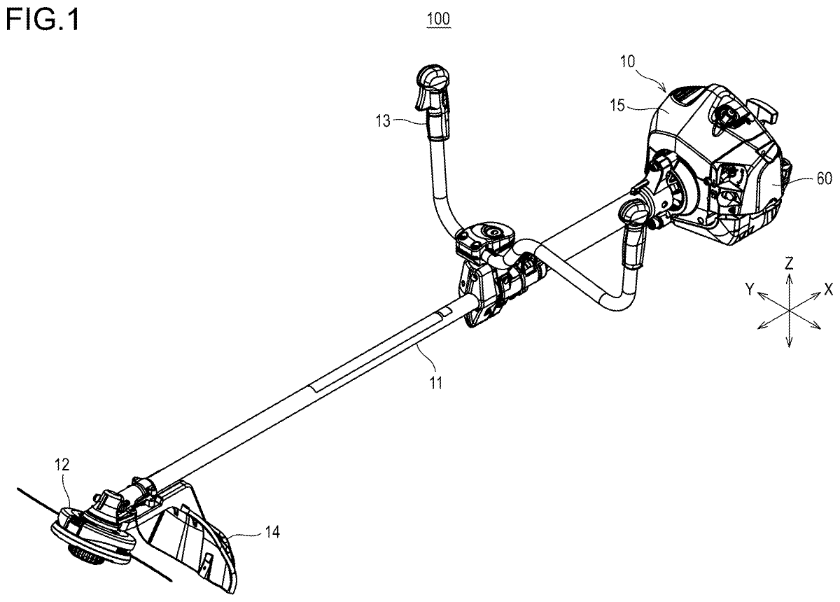

First, an embodiment will be described using FIGS. 1 to 10 (description of a comparative example compared with an embodiment is included).

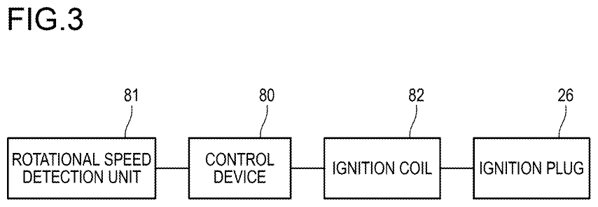

A control device 80 (FIG. 3) of an internal combustion engine for a portable work machine according to this embodiment controls the internal combustion engine for the portable work machine (for example, a brush cutter 100). The internal combustion engine (for example, a two-stroke engine 90) includes a combustion chamber (for example, a cylinder 21), an ignition plug 26 that ignites an air-fuel mixture supplied to the combustion chamber, and a crankshaft 27 as an output shaft.

When the rotational speed of the crankshaft 27 reaches a predetermined target rotational speed (for example, 12000 rpm), the control device 80 performs ATDC switching control in which the ignition timing of the ignition plug 26 is switched from a timing before a top dead center to a timing after the top dead center, and skip-fire control in which the number of ignitions of the ignition plug 26 per rotation is reduced.

The portable work machine (for example, the brush cutter 100) according to this embodiment is a portable work machine provided with an internal combustion engine (for example, the two-stroke engine 90) that includes the combustion chamber (for example, the cylinder 21), the ignition plug 26 that ignites the air-fuel mixture supplied to the combustion chamber, the crankshaft 27 as an output shaft, and a control unit (the control device 80). The control unit performs the ATDC switching control in which the ignition timing of the ignition plug 26 is switched from a timing before the top dead center to a timing after top dead center, and the skip-fire control in which the number of ignitions of the ignition plug 26 per rotation is reduced, when the rotational speed of the crankshaft 27 reaches the predetermined target rotational speed (for example, 12000 rpm).

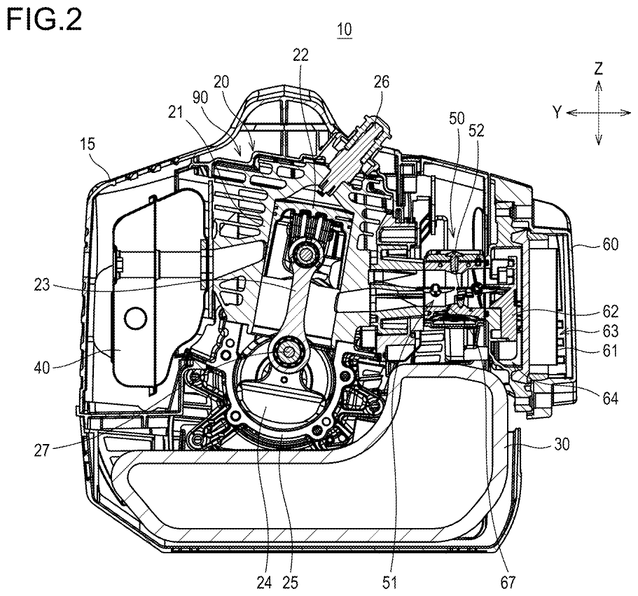

Here, “a timing after top dead center” includes the timing at which a piston 22 (FIG. 2) is exactly at the top dead center (namely, the timing at which a angular position of the crankshaft 27 is exactly 0 degree, provided that the piston 22 (FIG. 2) at the top dead center is 0 degree) and a timing after the top dead center. In other words, ignition after the top dead center by the ATDC switching control may be performed at the timing at exactly the top dead center. However, ignition after the top dead center by the ATDC switching control is preferably performed after the top dead center.

As is also the case with the technique of Japanese Laid-open patent publication NO. 2008-19863, for a conventional internal combustion engine for a portable work machine, the ignition timing of an ignition plug is generally before top dead center (BTDC), and an ignition timing after top dead center (ATDC) has been avoided.

As a result of study by the inventors of the present application, it was found that suppressing overspeed sufficiently is not easy when the ignition timing of the ignition plug is BTDC in a large-sized portable work machine that is required to provide engine performance with higher output (internal combustion engine performance).

In particular, for a layered scavenging engine, the amount of air introduced thereto is larger than that compared with an air-fuel mixture scavenging engine. Accordingly, the layered scavenging engine is known to have a tendency of providing high-speed output, and it is believed to be difficult to suppress overspeed sufficiently when the ignition timing of the ignition plug is BTDC.

In this embodiment, in the internal combustion engine for a portable work machine, the ignition timing of the ignition plug is switched to ATDC at the time of reaching the target rotational speed, and further, skip-fire control in which the number of ignitions of the ignition plug 26 per rotation is reduced is performed, whereby overspeed of the internal combustion engine can be suppressed more suitably. Since overspeed can be suppressed, adverse effect on the durability of a product or influence of vibration can also be suppressed.

That is, ignition is performed at a timing after the piston 22 (FIG. 2) reaches the top dead center, in other words, ignition is performed at the timing when the piston 22 is going to a bottom dead center, whereby an increase in combustion pressure can be suppressed. Further, repeated ignition and ignition skipping can suppress a rapid increase or a rapid decrease in combustion pressure, making it possible to maintain a stable combustion pressure cycle. As a result, it is possible to suppress rotations (stabilize the rotational speed) while the user's feelings (the way the user feels vibration (hand-arm vibration) or perceives sound) are kept in a favorable state.

Since rotations can be suppressed (since the rotational speed can be stabilized), it is also possible to suppress wearing of components in the engine, thereby improving the durability.

For example, even when the two-stroke engine 90 is tuned for higher output, overspeed can be suitably suppressed.

More detailed description will be provided hereinafter.

The portable work machine according to this embodiment is a work machine that is used while being carried by a user, such as a brush cutter, a chainsaw, or a blower.

The control device 80 according to this embodiment is used by being incorporated in an internal combustion engine of such a portable work machine.

Hereinafter, this embodiment will be described using, as an example, the case where the control device 80 is incorporated in the internal combustion engine of the brush cutter 100.

As shown in FIG. 1, the brush cutter 100 according to this embodiment includes, for example, an apparatus main body 10, a shaft 11 that extends in one direction from the apparatus main body 10, a rotary part 12 that is provided at a tip portion of the shaft 11, and an operating handle 13 that is provided for the shaft 11 and is to be grasped by a user.

The apparatus main body 10 includes a main body case 15 that forms an outer shell of the main body 10. The main body case 15 is formed from, for example, a plurality of components.

The apparatus main body 10 includes the two-stroke engine 90 (FIG. 2).

The driving force of the two-stroke engine 90 is transmitted to the rotary part 12 at the tip portion of the shaft 11 through a drive transmission mechanism to rotate the rotary part 12. By the rotation of the rotary part 12, an object to be cut, such as grasses, can be cut. More specifically, the shaft 11 is a hollow tube, and a transmission shaft not shown in the drawings is inserted through internal portion of the shaft 11. One end of the transmission shaft is connected to an output shaft of the two-stroke engine 90, and the other end thereof is connected to the rotary part 12, whereby the driving force of the two-stroke engine 90 is transmitted to the rotary part 12, which is a work part.

A guard part 14 that hinders grasses or the like cut by the rotary part 12 from flying toward the user side is provided at a position on the side where the operating handle 13 and the apparatus main body 10 are placed with respect to the rotary part 12.

For the simplicity of description, description hereinafter will be made using an X direction, a Y direction, and a Z direction that are shown in FIG. 1. The Y direction and the Z direction are also shown in FIG. 2. The X direction, the Y direction, and the Z direction are orthogonal to each other.

The X direction is a direction in which the shaft 11 extends.

The user of the brush cutter 100 uses the brush cutter 100 typically by grasping the operating handle 13 in a posture that allows the operating handle 13 to be located above the shaft 11.

When the user grasps the operating handle 13 in front of the user and uses the brush cutter 100 in a posture such that the tip (the part where the rotary part 12 is provided) of the shaft 11 is located further ahead of the operating handle 13, the X direction is an approximately back or front direction with respect to the user, and the Y direction is an approximately right or left direction with respect to the user. The Z direction is an approximately up or down direction with respect to the user.

As shown in FIG. 2, the apparatus main body 10 includes the two-stroke engine 90.

The apparatus main body 10 includes an engine block 20, a diaphragm carburetor 50, an air cleaner 60, a fuel tank 30, and an exhaust part 40.

The air cleaner 60 includes an air filter 61 that filters external air, a primary side space 63 that is a space outside the air filter 61 (external air side), and a secondary side space 64 that is a space inside the air filter 61 (a gas supply passageway 51 side).

In the secondary side space 64, an opposing plate 62 is provided, which suppresses contamination of the air filter 61 with air-fuel mixture by rebounding the air-fuel mixture flowing backward from the gas supply passageway 51 of the diaphragm carburetor 50.

Although the diaphragm carburetor 50 will not be described in detail, the diaphragm carburetor 50 includes: the gas supply passageway 51 that supplies, to the engine block 20, air introduced into the secondary side space 64; a throttle valve 52 provided for the gas supply passageway 51; a regulation chamber that stores fuel supplied from the fuel tank 30; a fuel nozzle that injects fuel in the regulation chamber into the gas supply passageway 51; a diaphragm; and the like.

When a pressure in the gas supply passageway 51 becomes negative, fuel is introduced from the regulation chamber into the gas supply passageway 51, and the air-fuel mixture in which the fuel and the air intake are mixed is supplied to the combustion chamber.

The gas supply passageway 51 has a partially reduced diameter and forms a venturi.

One end side of the fuel nozzle opens into a narrow part of the gas supply passageway 51, and the other end side of the fuel nozzle 67 is in communication with the regulation chamber.

The fuel in the regulation chamber is injected like mist to the inside of the gas supply passageway 51 through the fuel nozzle when the pressure in the gas supply passageway 51 (particularly the reduced diameter portion) becomes negative.

The engine block 20 is also called a cylinder block and includes the cylinder 21, the piston 22 housed in the cylinder 21 and capable of reciprocating motion, a crankcase 25 having a bore region in communication with the cylinder 21, a crank 24 provided in the crankcase 25, a connecting rod 23 that couples the crank 24 to the piston 22, the crankshaft 27 integrally provided for the crank 24, the ignition plug 26, and the control device 80 which will be described later.

Note that FIG. 2 is a cross sectional view taken along a plane including a central axis of the connecting rod 23.

In the engine block 20 of the two-stroke engine 90, the piston 22 makes one reciprocating motion for each cycle.

A side surface of the cylinder 21 is provided with an intake passageway that supplies an air-fuel mixture from the gas supply passageway 51 to the crankcase 25, a scavenge passageway that connects the cylinder 21 to the crankcase 25, and an exhaust passageway that discharges gas from the cylinder 21.

In the air-fuel mixture scavenging engine, in the process of the piston 22 going to the top dead center, the crankcase 25 is placed under a negative pressure and an air-fuel mixture is thus introduced from the intake passageway into the crankcase 25. In the latter half of the process, the air-fuel mixture is compressed in the cylinder 21 in a state where an exhaust port and a scavenge port are blocked by the piston 22.

The air-fuel mixture ignited by a spark from the ignition plug 26 burns (explodes) in the cylinder 21, whereby the piston 22 goes to the bottom dead center and in the latter half of the process, the exhaust passageway and the scavenge passageway are released from the state of being blocked by the piston 22 and exhaust through the exhaust passageway is started, and intake from the crankcase 25 to the cylinder 21 through the scavenge passageway takes place.

Note that in the present invention, the timing at which ignition after the top dead center by the ATDC switching control is performed, namely “a timing after the top dead center”, is a timing before the exhaust passageway starts to be released from the state of being blocked by the piston 22 in the process of the piston 22 going to the bottom dead center, that is, a timing at which the exhaust passageway is still blocked by the piston 22.

The fuel tank 30 stores fuel (liquid fuel) such as gasoline therein. The fuel in the fuel tank 30 is supplied to the engine block 20 through the diaphragm carburetor 50.

A gas discharged from the engine block 20 is introduced into the exhaust part 40 and then discharged to the outside.

The two-stroke engine 90 includes a rotational speed detection unit 81, the control device 80, and an ignition coil 82, as shown in FIG. 3.

The control device 80 includes a microcomputer and various electronic components. The microcomputer includes: a ROM that stores and holds a control program; a CPU that executes control operation in accordance with the control program; a RAM that serves as a work area or the like for the CPU; an input/output circuit; and the like. The electronic components include a switching element, a capacitor that serves as a battery (a power supply) having a small size and a small capacity, a diode, a resistor, a terminal, and the like.

The control device 80 causes the capacitor to be discharged at a timing dependent on the rotation angle (crank angle) of the crankshaft 27 so as to generate a high voltage momentarily at the ignition coil 82, and applies the high voltage to the ignition plug 26 through a cable, whereby spark discharge (ignition) is made to occur across a plug gap, making ignition in synchronization with the rotation of the crankshaft 27.

The control device 80 thus performs control of the ignition operation of the ignition plug 26, or the like.

The two-stroke engine 90 includes a flywheel provided for the crankshaft 27, and the flywheel is provided with a magnet.

Here, the above-described ignition coil 82 is also called a secondary coil, and the two-stroke engine 90 includes a primary coil in addition to the ignition coil 82 (the secondary coil).

When the magnet provided for the flywheel passes near the primary coil, a pulse voltage is induced in the primary coil. The induced pulse voltage is divided into a main voltage portion for ignition and a sub voltage portion for use in detecting the rotational speed or the like. The main voltage portion is supplied to the above-described capacitor. The main voltage portion is used not only for ignition but also as a power supply for operation of the CPU or the like in the control device 80. The sub voltage portion is used as a rotation signal.

The rotational speed detection unit 81 detects (counts) the number of rotations of the flywheel per unit time, that is, the number of rotations of the crankshaft 27 per unit time, on the basis of the rotation signal, and the detection results are output to the control device 80.

The control device 80 performs control of the ignition operation (the timing of ignition (ignition timing), and whether ignition skipping is performed) of the ignition plug 26 in accordance with the rotational speed (the number of rotations per minute) detected by the rotational speed detection unit 81. Note that the timing herein means a timing that is based on the rotation angle of the crankshaft 27 and is not necessarily consistent with a timing based on lapse of time.

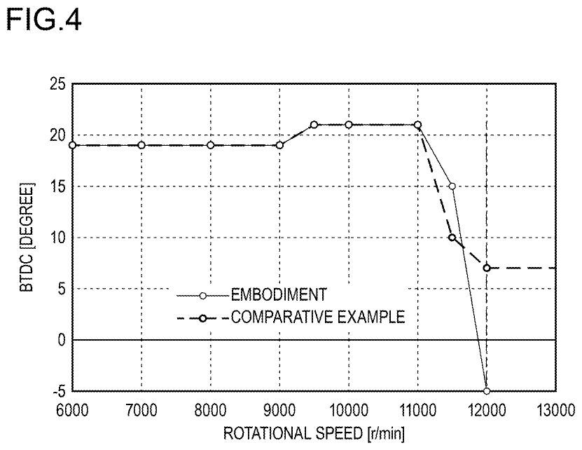

Here, FIG. 4 is a graph illustrating control by control devices of brush cutters according to the embodiment and a comparative example; the axis of abscissas represents the rotational speed and the axis of ordinates represents ignition timing (the crank angle) based on the top dead center.

A solid line in FIG. 4 corresponds to the embodiment, and a dashed line in FIG. 4 corresponds to the comparative example.

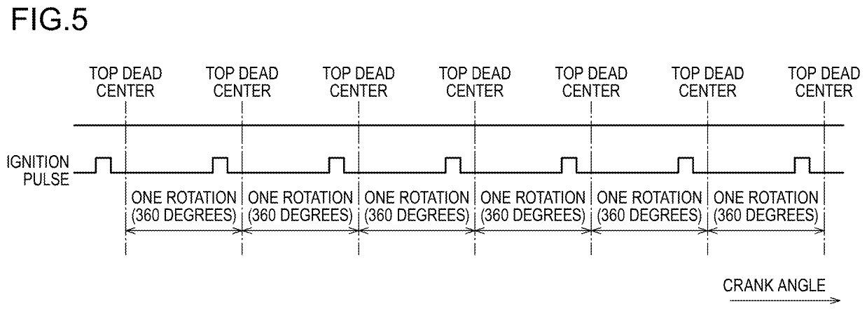

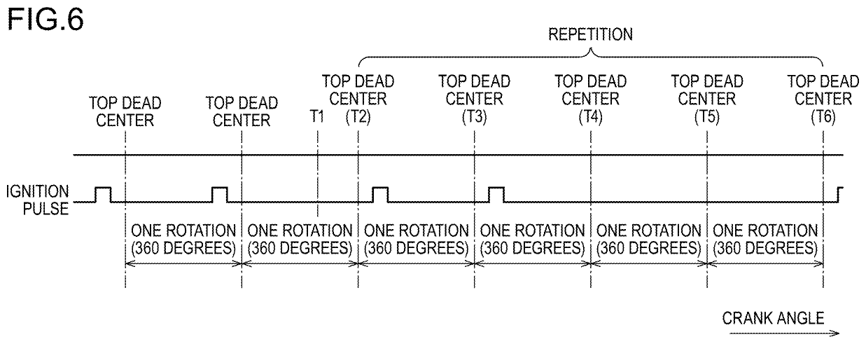

In the case of this embodiment, as shown in FIGS. 4 and 5, when the rotational speed is less than 12000 rpm, the ignition plug 26 is ignited in a BTDC (before top dead center) range, but as shown in FIGS. 4 and 6, the ignition plug 26 is ignited in a ATDC (after top dead center) range (in more detail, a range of later than the top dead center) at the time of reaching 12000 rpm (after timing T1 shown in FIG. 6).

After the rotational speed reached 12000 rpm, the ignition timing of the ignition plug 26 is changed to ATDC (the ATDC switching control is performed), and further, the skip-fire control in which the number of ignitions of the ignition plug 26 per rotation is reduced is performed as shown in FIG. 6.

Here, “ignition pulse” shown in FIGS. 5 and 6 indicates that the above-described high voltage is applied from the capacitor to the ignition coil 82. Every time one ignition pulse occurs, the ignition plug 26 is ignited once.

In the case of this embodiment, since the internal combustion engine is the two-stroke engine 90, the skip-fire control means control in which the number of ignitions of the ignition plug 26 is made smaller than the number of rotations of the crankshaft 27; in a normal state in which the skip-fire control is not performed, the ignition of the ignition plug 26 is performed once every time the crankshaft 27 rotates once (FIG. 5). That is, in the normal state in which the ATDC switching control and the skip-fire control are not performed, one ignition pulse occurs in the BTDC range every time the crankshaft 27 rotates once.

Meanwhile, in FIG. 6, the timing T1 denotes a time point of reaching the target rotational speed (12000 rpm in this embodiment). As shown in FIG. 6, at the time of reaching 12000 rpm (after the timing T1 shown in FIG. 6), the ATDC switching control and the skip-fire control are performed. Hence, the ignition pulse occurs in the ATDC range and the number of ignitions of the ignition plug 26 per rotation is reduced.

The ignition timing of the ignition plug 26 is switched to ATDC (the ATDC switching control is performed), and the skip-fire control in which the number of ignitions of the ignition plug 26 per rotation is reduced is also performed, whereby the rotational speed of the two-stroke engine 90 can be sufficiently reduced, so that overspeed of the two-stroke engine 90 can be favorably suppressed.

More specifically, as shown in FIG. 4, in a range of equal to or more than 6000 rpm and less than 9500 rpm, the ignition plug 26 is ignited at the timing of, for example, 19 degrees before the top dead center.

In a range of equal to or more than 9500 rpm and less than 11500 rpm, the ignition plug 26 is ignited at the timing of, for example, 21 degrees before the top dead center.

In a range of equal to or more than 11500 rpm and less than 12000 rpm, the ignition plug 26 is ignited at the timing of, for example, 15 degrees before the top dead center.

In a range of equal to or more than 12000 rpm, the ignition plug 26 is ignited at the timing of, for example, 5 degrees after top dead center (ATDC). Further, the skip-fire control is performed as shown in FIG. 6.

Here, the ignition is performed at the timing before the top dead center, the timing being earlier in the range of equal to or more than 9500 rpm and less than 11500 rpm (a high-speed range near the target rotational speed) than the case in the range of equal to or more than 6000 rpm and less than 9500 rpm (a low-speed range to a middle-speed range). The reason for the earlier timing of the ignition is that the rotational speed can reach the target rotational speed (for example, 12000 rpm) more speedily.

In this embodiment, the rotational speed at which the ATDC switching control and the skip-fire control are performed is when the rotational speed further increases and reaches the target rotational speed, in the high-speed range near the target rotational speed (for example, the range of equal to or more than 9500 rpm and less than 11500 rpm), after ignition timing is set more earlier than the top dead center compared in a low-speed range (for example, the range of equal to or more than 6000 rpm and less than 9500 rpm).

As above, in the ATDC switching control, the ignition timing of the ignition plug 26 is set in a range of less than 10 degrees from the top dead center (the timing of 5 degrees from the top dead center in the case of this embodiment).

Accordingly, the rotational speed can be sufficiently suppressed, and an excessive decrease of output can be suppressed (compared with the case in a range of equal to or more than 10 degrees from the top dead center).

The target rotational speed is the predetermined rotational speed which is equal to or more than 10000 rpm. When the target rotational speed is the predetermined rotational speed which is equal to or more than 10000 rpm, necessary output can be ensured, and further, an excessive increase of vibration can be suppressed.

The target rotational speed is preferably a predetermined rotational speed which is equal to or more than 11000 rpm, and 12000 rpm in the case of this embodiment.

By the ATDC switching control and the skip-fire control, when the rotational speed is decreased to 11500 rpm, the control device 80 returns to the operation in which, as shown in FIG. 4, the ignition plug 26 is ignited at the timing of 15 degrees before the top dead center and returns to the operation in which, as shown in FIG. 5, the skip-fire control is not performed and the ignition plug 26 is ignited once per rotation.

In a similar manner, in the case where the rotational speed is decreased to 11000 rpm, the control device 80 returns to the operation in which, as shown in FIG. 4, the ignition plug 26 is ignited at the timing of 21 degrees before the top dead center and returns to the operation in which, as shown in FIG. 5, the skip-fire control is not performed and the ignition plug 26 is ignited once per rotation.

In a similar manner, in the case where the rotational speed is decreased to 9000 rpm, the control device 80 returns to the operation in which, as shown in FIG. 4, the ignition plug 26 is ignited at the timing of 19 degrees before the top dead center, and returns to the operation in which, as shown in FIG. 5, the skip-fire control is not performed and the ignition plug 26 is ignited once per rotation.

As shown in FIG. 6, in the skip-fire control in the case of this embodiment, the ignition pulse is made to occur after the timing T2 which is the first time of reaching the top dead center after the timing T1, and also after timing T3 which is the second time of reaching the top dead center after the timing T1; however, the ignition pulse is not made to occur (ignition skipping is made to occur) after timing T4 which is the third time of reaching the top dead center after the timing T1, and also after timing T5 which is the fourth time of reaching the top dead center after the timing T1.

After the timing T4, operation from the timing T2 to timing T6 is repeatedly performed as long as the rotational speed keeps a state of exceeding 11500 rpm.

That is, in the skip-fire control, ignition skipping for two successive rotations and ignition for two successive rotations are alternately and repeatedly performed.

As above, in the case of this embodiment, ignition skipping for a plurality of successive rotations and ignition are alternately and repeatedly performed in the skip-fire control. The ignition skipping for a plurality of successive rotations can suppress the vibration favorably.

More specifically, ignition skipping for a plurality of successive rotations and ignition for a plurality of successive rotations are alternately and repeatedly performed in the skip-fire control. Thus, the vibration can be favorably suppressed, and further, discharging of an unburned air-fuel mixture to the exhaust part 40 can be favorably suppressed.

As a result of try and error of the skip-fire control under various conditions by the inventors of the present application, in the skip-fire control in the brush cutter 100 of a large size, the most effective way is to perform ignition skipping for two successive rotations and ignition for two successive rotations alternately and repeatedly, in terms of suppressing the vibration favorably and suppressing discharge of the unburned air-fuel mixture to the exhaust part 40.

As shown in FIG. 4, in addition to the above-described ATDC switching control, retard control to bring the ignition timing of the ignition plug 26 closer to the top dead center is performed when the rotational speed is increased in a speed range lower than at the target rotational speed.

That is, when the rotational speed is increased to 11500 rpm, the ignition timing of the ignition plug 26 is brought closer to the top dead center (for example, the timing is set to be 15 degrees before the top dead center) compared with the time when the rotational speed is less than 11500 rpm (when the ignition plug 26 is ignited at the timing of 21 degrees before the top dead center).

In other words, before the ATDC switching control and the skip-fire control are performed, the retard control is also performed as preparatory operation. That is, in the range of equal to or more than 11500 rpm and less than 12000 rpm, control to bring the ignition timing closer to the top dead center (compared with the time when the rotational speed is less than that) is performed.

Thus, it is possible to reduce a difference in output between before conducting the retard control (in the range of equal to or more than 9500 rpm and less than 11500 rpm in the case of this embodiment) and when the output decreases by the ATDC switching control and the skip-fire control, and hence, the user's feelings can be kept in a favorable state.

Here, in the above-described retard control, the ignition timing of the ignition plug 26 is switched from a state of 21 degrees before the top dead center (less than 11500 rpm) to a state of 15 degrees before the top dead center (equal to or more than 11500 rpm), and therefore, an angular difference caused by the retard control is 6 degrees.

In contrast, in the ATDC switching control, the ignition timing of the ignition plug 26 is switched from a state of 15 degrees before the top dead center (less than 12000 rpm) to a state of 5 degrees after the top dead center (equal to or more than 12000 rpm), and therefore, an angular difference caused by the ATDC switching control is 20 degrees.

That is, an angle changed by the ATDC switching control is larger than an angle changed by the retard control.

This means that an angular difference between the ignition timing when the retard control is performed and the ignition timing when the ATDC switching control is performed is larger than an angular difference between the ignition timing in a speed range lower than when the retard control is performed and the ignition timing when the retard control is performed.

Thus, the rotational speed can be reduced more sufficiently and speedily by the ATDC switching control.

As shown in FIG. 6, in the case of this embodiment, ignition skipping (ignition skipping immediately after the timing T4 and ignition skipping immediately after the timing T5) by the skip-fire control is started at the timing after ignition after the top dead center by the ATDC switching control (ignition immediately after the timing T2 and immediately after the timing T3) is performed.

As above, in the case where the ignition skipping by the skip-fire control is performed after the ignition after the top dead center by the ATDC switching control, a gentle decline of power is possible, which can prevent the user's feelings from becoming worse.

Here, the comparative example compared with this embodiment will be described.

A brush cutter according to the comparative example is different from the brush cutter 100 according to this embodiment in that the above-described ATDC switching control and skip-fire control are not performed, and the other points are configured in a manner similar to the brush cutter 100 according to this embodiment.

More specifically, in the case of the comparative example, as shown in FIG. 4, control at the time of rotational speed is less than 11500 rpm is similar to that in this embodiment; however, when the rotational speed reaches 11500 rpm, the ignition plug is ignited at the timing of 10 degrees before the top dead center, and, when the rotational speed reaches equal to or more than 12000 rpm, the ignition plug is ignited at the timing of 7 degrees before the top dead center.

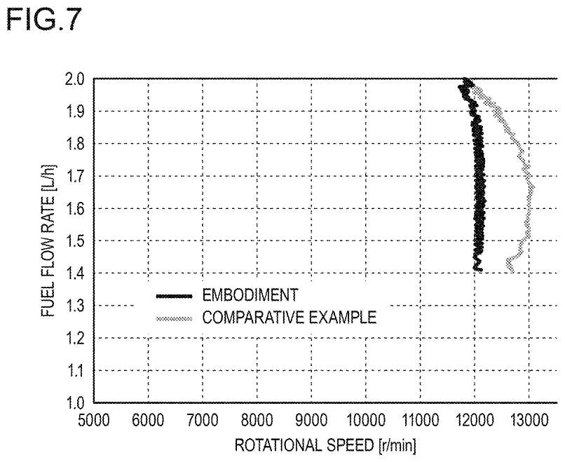

FIG. 7 is a graph showing the relationship between the fuel flow rate (a flow rate per unit time=an amount of consuming fuel per unit time) and the rotational speed of the brush cutter 100 according to the embodiment and the brush cutter according to the comparative example.

In two curves shown in FIG. 7, the black solid line corresponds to the embodiment and the gray solid line corresponds to the comparative example.

As shown in FIG. 7, in the case of the comparative example, the rotational speed is changed (changed between approximately 12000 rpm and 13000 rpm) in accordance with the change of the flow rate; in contrast, in the case of this embodiment, the rotational speed is maintained at approximately 12000 rpm even when the flow rate is changed.

That is, according to this embodiment, the rotational speed is stable with respect to the change of the fuel flow rate as compared with the comparative example.

The fuel flow rate varies among individuals of products or depending on use conditions (temperature conditions and the like) thereof; however, even when such variations are caused, it can be said that the rotational speed is stable and the output can also be made stable according to this embodiment.

TABLE 1

| | Average combustion | Maximum combustion |
|---|---|---|
| | pressure (MPa) | pressure (MPa) |
| Comparative example | 1.77 | 2.20 |
| Embodiment | 1.71 | 1.91 |
| Combustion pressure | −4% | −13% |
| reduction rate | | |

As shown in Table 1, according to this embodiment, an average combustion pressure in the combustion chamber can be reduced by 4% (−4% of the average combustion pressure can be achieved) and a maximum combustion pressure can be reduced by 13% (−13% of the maximum combustion pressure can be achieved) as compared with the comparative example.

As above, in this embodiment, the combustion pressure can be made stable and reduced; this also shows that it is possible to suppress overspeed and reduce the vibrations of the engine block 20 and the diaphragm carburetor 50.

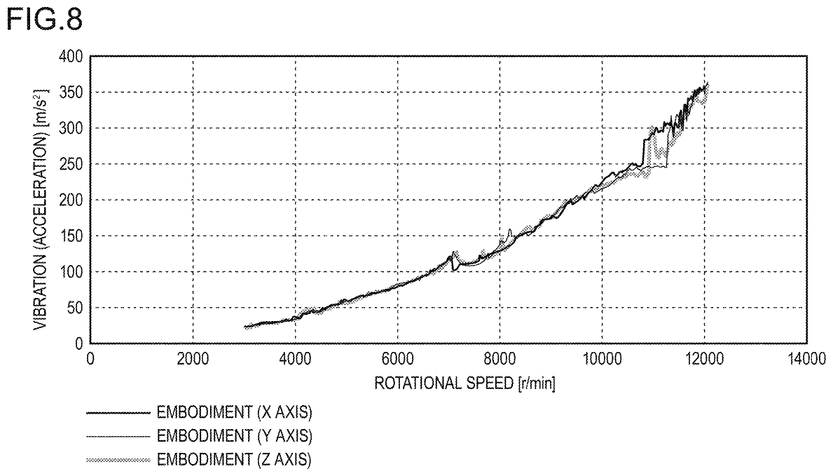

FIG. 8 is a graph showing the relationship between the rotational speed and the vibrations (acceleration) of the brush cutter 100 according to an embodiment.

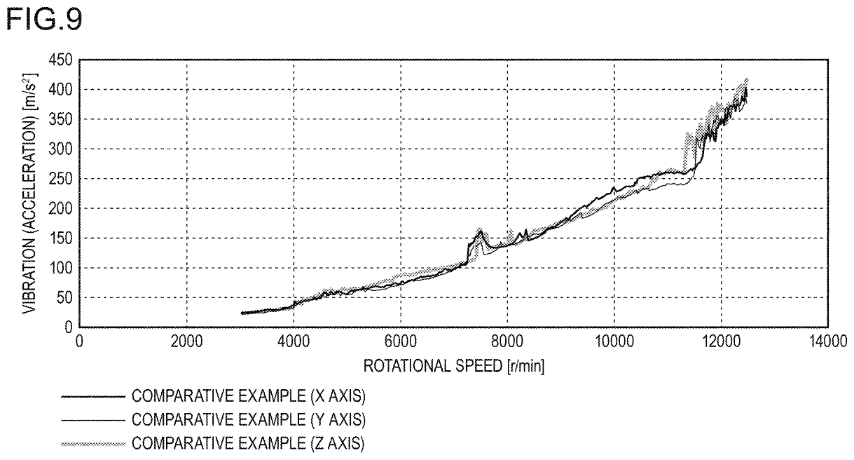

FIG. 9 is a graph showing the relationship between the rotational speed and the vibrations (acceleration) of the brush cutter according to the comparative example.

In each of FIGS. 8 and 9, three curves are shown. In these three curves, the black bold solid line denotes the measurement result of vibrations, in a X-axis direction (the X direction described above), of the cylinder 21, the black thin solid line denotes the measurement result of vibrations, in a Y-axis direction (the Y direction described above), of the cylinder 21, and the gray solid line denotes the measurement result of vibrations, in a Z-axis direction (the Z direction described above), of the cylinder 21.

These measurements are performed with the throttle valve 52 opened at maximum.

Though the vibrations increase with the increase in the rotational speed, in the case of this embodiment, the rotational speed can be maintained to be approximately equal to or less than 12000 rpm, and hence, the vibrations can also be reduced in accordance with the rotational speed.

In contrast, in the case of the comparative example, the rotational speed exceeds 12000 rpm, and hence, the vibrations are also at a high level in accordance with the rotational speed.

The three curves shown in FIG. 8 exhibit mutually similar trends. The three curves shown in FIG. 9 also exhibit mutually similar trends.

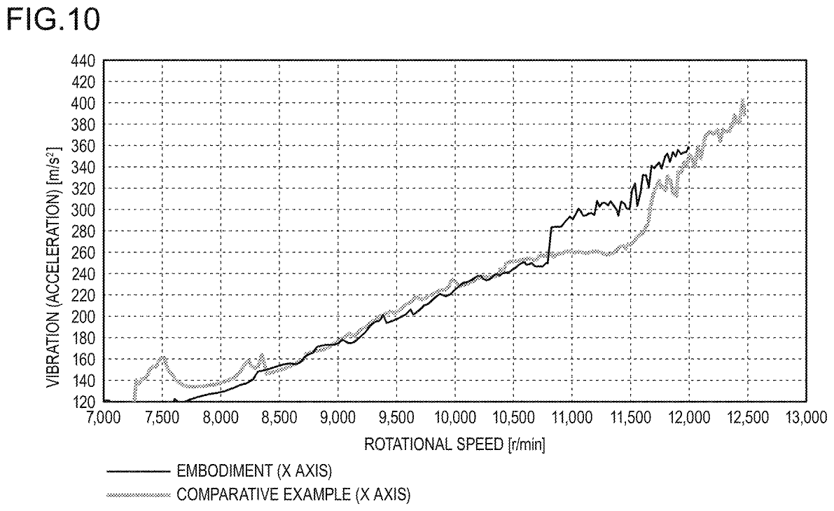

FIG. 10 shows the measurement result of the vibrations in the X-axis direction which is excerpted from the three curves shown in FIG. 8 as a representative example (denoted by the black bold solid line in FIG. 10), and shows the measurement result of the vibrations in the X-axis direction which is excerpted from the three curves shown in FIG. 9 as a representative example (denoted by the gray solid line in FIG. 10).

It is also shown from FIG. 10 that an increase in vibration value can be suppressed in this embodiment as compared with the comparative example.

Here, as a result of the study conducted by the inventors of the present application, the technique of Japanese Laid-open patent publication NO. 2008-19863 is close to the technique of the above-described comparative example, and uses control in which ignition and ignition skipping (gradually increase the number of ignition skipping) in the BTDC range are performed and the rotational speed is forcibly suppressed; accordingly, the combustion pressure varies largely, and it cannot be said that the user's feelings are fine.

### Modification Example

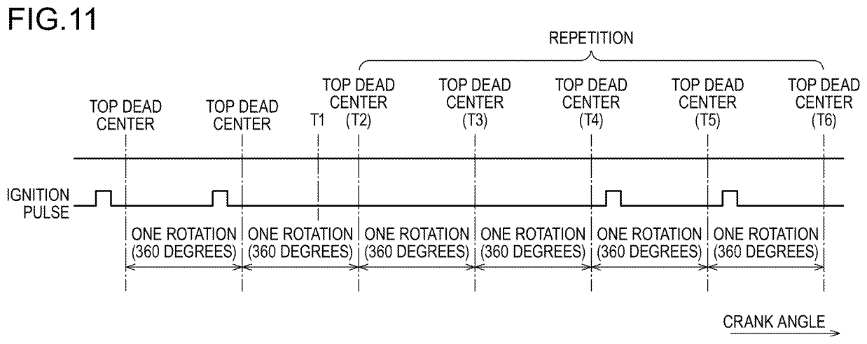

Next, a control device according to a modification example is described using FIG. 11.

Control conducted by the control device according to the present modification example is different from the control conducted by the control device 80 according to the above-described embodiment in points to be described below, and the other points are similar to those in the control conducted by the control device 80 according to the above-described embodiment.

The brush cutter according to the present modification example is configured in a manner similar to the brush cutter 100 according to the above-described embodiment, except that control conducted by the control device is different from the control by the control device in the above-described embodiment.

As shown in FIG. 11, in the case of the present modification example, ignition after the top dead center by the ATDC switching control (ignition immediately after the timing T4 and ignition immediately after the timing T5) is started at the timing after the ignition skipping (ignition skipping immediately after the timing T2 and ignition skipping immediately after the timing T3) by the skip-fire control is started.

As above, in the case where the ignition skipping by the skip-fire control is performed before the ignition after the top dead center by the ATDC switching control, the power can be drastically lowered and it is therefore effective in suppressing an increase in the rotational speed more speedily.

Although the embodiment and the modification example are described above with reference to the drawings, these are merely examples of the present invention and various configurations other than those described above can be employed.

This embodiment includes the following technical concept.
(1) A control device of an internal combustion engine for a portable work machine, the control device being configured to perform control of the internal combustion engine of the portable work machine, the portable work machine including the internal combustion engine including a combustion chamber, an ignition plug that ignites an air-fuel mixture supplied to the combustion chamber, and a crankshaft as an output shaft,
wherein, when a rotational speed of the crankshaft reaches a predetermined target rotational speed, the control device performs ATDC switching control in which an ignition timing of the ignition plug is switched from a timing before a top dead center to a timing after the top dead center, and skip-fire control in which the number of ignitions of the ignition plug per rotation is reduced.
(2) The control device of an internal combustion engine for a portable work machine according to (1), wherein, in the ATDC switching control, the ignition timing of the ignition plug is set to a range of less than 10 degrees from the top dead center.
(3) The control device of an internal combustion engine for a portable work machine according to (1) or (2), wherein the target rotational speed is a predetermined rotational speed of equal to or more than 10000 rpm.
(4) The control device of an internal combustion engine for a portable work machine according to any one of (1) to (3), wherein, in the skip-fire control, ignition skipping for a plurality of successive rotations and ignition are alternately and repeatedly performed.
(5) The control device of an internal combustion engine for a portable work machine according to (4), wherein, in the skip-fire control, ignition skipping for a plurality of successive rotations and ignition for a plurality of successive rotations are alternately and repeatedly performed.
(6) The control device of an internal combustion engine for a portable work machine according to (5), wherein, in the skip-fire control, ignition skipping for two successive rotations and ignition for two successive rotations are alternately and repeatedly performed.
(7) The control device of an internal combustion engine for a portable work machine according to any one of (1) to (6), wherein, in a speed range lower than the target rotational speed, retard control to bring the ignition timing of the ignition plug closer to the top dead center is performed when the rotational speed is increased.
(8) The control device of an internal combustion engine for a portable work machine according to (7), wherein
an angular difference between an ignition timing when retard control is performed and the ignition timing when the ATDC switching control is performed is larger than
an angular difference between an ignition timing in a speed range lower than when the retard control is performed and the ignition timing when the retard control is performed.
(9) The control device of an internal combustion engine for a portable work machine according to any one of (1) to (8), wherein ignition skipping by the skip-fire control is started at a timing after ignition after the top dead center by the ATDC switching control is performed.
(10) The control device of an internal combustion engine for a portable work machine according to any one of (1) to (8), wherein ignition after the top dead center by the ATDC switching control is started at a timing after ignition skipping by the skip-fire control is started.
(11) A portable work machine including an internal combustion engine including a combustion chamber, an ignition plug that ignites an air-fuel mixture supplied to the combustion chamber, a crankshaft as an output shaft, and
a control unit,
wherein the control unit is configured to perform ATDC switching control in which an ignition timing of the ignition plug is switched from a timing before a top dead center to a timing after the top dead center, and skip-fire control in which the number of ignitions of the ignition plug per rotation is reduced, when the rotational speed of the crankshaft reaches the predetermined target rotational speed.

What is claimed is:

1. A control device of an internal combustion engine for a portable work machine, the control device being configured to perform control of the internal combustion engine of the portable work machine, the portable work machine comprising the internal combustion engine comprising a combustion chamber, an ignition plug that ignites an air-fuel mixture supplied to the combustion chamber, and a crankshaft as an output shaft,
wherein, when a rotational speed of the crankshaft reaches a predetermined target rotational speed, the control device performs ATDC switching control in which an ignition timing of the ignition plug is switched from a timing before a top dead center to a timing after the top dead center, and skip-fire control in which the number of ignitions of the ignition plug per rotation is reduced.

2. The control device of an internal combustion engine for a portable work machine according to claim 1, wherein, in the ATDC switching control, the ignition timing of the ignition plug is set in a range of less than 10 degrees from the top dead center.

3. The control device of an internal combustion engine for a portable work machine according to claim 1, wherein the target rotational speed is a predetermined rotational speed of equal to or more than 10000 rpm.

4. The control device of an internal combustion engine for a portable work machine according to claim 1, wherein, in the skip-fire control, ignition skipping for a plurality of successive rotations and ignition are alternately and repeatedly performed.

5. The control device of an internal combustion engine for a portable work machine according to claim 4, wherein, in the skip-fire control, ignition skipping for a plurality of successive rotations and ignition for a plurality of successive rotations are alternately and repeatedly performed.

6. The control device of an internal combustion engine for a portable work machine according to claim 5, wherein, in the skip-fire control, ignition skipping for two successive rotations and ignition for two successive rotations are alternately and repeatedly performed.

7. The control device of an internal combustion engine for a portable work machine according to claim 1, wherein, in a speed range lower than the target rotational speed, retard control to bring the ignition timing of the ignition plug closer to the top dead center is performed when the rotational speed is increased.

8. The control device of an internal combustion engine for a portable work machine according to claim 7, wherein
an angular difference between an ignition timing when the retard control is performed and the ignition timing when the ATDC switching control is performed is larger than
an angular difference between an ignition timing in a speed range lower than when the retard control is performed and the ignition timing when the retard control is performed.

9. The control device of an internal combustion engine for a portable work machine according to claim 1, wherein ignition skipping by the skip-fire control is started at a timing after ignition after the top dead center by the ATDC switching control is performed.

10. The control device of an internal combustion engine for a portable work machine according to claim 1, wherein ignition after the top dead center by the ATDC switching control is started at a timing after ignition skipping by the skip-fire control is started.

11. A portable work machine comprising:
an internal combustion engine comprising:
a combustion chamber;
an ignition plug that ignites an air-fuel mixture supplied to the combustion chamber;
a crankshaft as an output shaft; and
a control unit,
wherein the control unit is configured to perform ATDC switching control in which an ignition timing of the ignition plug is switched from a timing before a top dead center to a timing after the top dead center, and skip-fire control in which the number of ignitions of the ignition plug per rotation is reduced, when the rotational speed of the crankshaft reaches the predetermined target rotational speed.
